(19) United States
(12) Patent Application Publication
(10) Pub. No.: US 2007/0190508 A1
(43) Pub. Date: Aug. 16, 2007

(54) Exercise method for physical and mental integration

(76) Inventor: Curtis Randall Dalton, Middleton, MA (US)

Correspondence Address: MICHAEL RIES, 318 PARKER PLACE, OSWEGO, IL, 60543, US

(21) Appl. No.: 11/706,482

(22) Filed: Feb. 14, 2007

Related U.S. Application Data
(60) Provisional application No. 60/774,363, filed on Feb. 16, 2006.

(51) Int. Cl. G09B 23/28

(52) U.S. Cl. 434/262

(57) ABSTRACT

The present invention is a detailed instructional method for mind, body, and spiritual integration. The instant invention is based on a concerted series of sessions that combine the components of yogic focusing, physical exercise, and inspirational music. The physical exercise component may be obtained via indoor cycling using a stationary cycling machine. Other exercise machines and meditation practices may be equivalently substituted.

This application claims the benefit of U.S. provisional patent application Ser. No. 60/774,363, filed Feb. 16, 2006.

### TECHNICAL FIELD & BACKGROUND

The present invention generally pertains to methods of aiding human physical and mental wellness. More specifically, the present invention relates to a detailed instructional method for mind, body, and spiritual integration. The instant invention is based on a concerted series of sessions led by an instructor that combine the components of yogic practice, physical exercise, and inspirational music. The physical exercise component is preferably obtained via indoor cycling using a stationary cycling machine, although other forms of meditation and aerobic exercise may substituted.

Human health is generally attributed to wellness, which is a more general concept, further acknowledged to be a favorable aspect of integrating the human mind and body in a proper format. Wellness implies the total emotional and physical health of a human being, not simply freedom from physical disease.

Many philosophers, thinkers, and spiritual leaders describe the human individual as possessing not only a mind, but also a spirit, in addition to a physical form. When any one of these three human components is unbalanced or functions in opposition to the others, human wellness is practically compromised. The human spirit is hard to identify, even subjectively, but by custom is felt to relate to a higher, overriding sense of consciousness, which when personally accessed can be experienced as a sense of focus, calmness, wellness, and goodwill.

Challenging physical exercise is universally seen as beneficial to the human body, in terms of strengthening and conditioning. This exercise is also especially beneficial when the exercise is of sufficient duration and intensity to evoke cardio protective effects, such that the heart and cardiovascular system are strengthened. Physiologists indicate that such exercises are characterized minimally by moderate body movement for roughly 30 minutes, sufficient to elevate heart rate while maintaining aerobic breathing.

To obtain cardiac benefit through regimented exercise, one common practice is to use bicycling, in fixed or mobile form. Compared to a practice such as recreational running, bicycling is beneficial because it is protective of leg and hip joints due to its repetitive but low impact nature. In fixed form, as with an immobilized cycling machine, bicycling is especially favorable because it obviates the dangers of trauma from collision or falling and because it can be performed in a small space, such as an instructional area.

Those skilled in the art will recognize that other forms of aerobic exercise using different mechanical devices will provide cardiovascular benefits equal to those of a cycling machine, and these devices may be freely substituted for the cycling machine.

Yogic practice is a widely used, ancient integrative physical and mental practice that combines controlled stretching with meditation to produce a spiritual benefit. Yogic practice, also known as yoga, while beneficial, is typically sedentary. Thus, it does not provide the cardio protective advantage of an aerobic exercise such as bicycling.

Those skilled in the art will recognize that other forms of meditation may be equivalent in effectiveness to the practice of yoga and that these forms of meditation may be substituted in the method to be described below.

Additionally, one well-known environmental stimulus for affecting feeling and mood is music. Positive, energetic, harmonic tones, along with a powerful tempo and beat and their interaction with the psyche can produce a sense of physical energy and emotional elation in humans.

In one embodiment, the current invention integrates yogic practice and cycling in a unique combination, under the appropriate influence of music, to provide a method for integrating mind, body, and spirit. The method is highly adaptable to public instruction, and is favorably used with an experienced instructor in a classroom setting. However, It may also be practiced individually.

### SUMMARY OF THE INVENTION

The present invention provides method for aiding human wellness through meditation and physical exercise, combined with music. In one embodiment, the method is practiced in three segments performed in succession over a period of about one hour, preferably in an indoor instructional area.

The present method provides an introductory warm-up session of yoga during which muscles are gently activated, joints are warmed and lubricated, and awareness is focused on the body. This warm-up session is followed by an extended period of cardio protective, aerobic exercise using a fixed bicycle machine. The final segment is a complementary yoga session, constructed to refocus the mind and calm the body, which cools down the body in a controlled way. Selected music is played to increase the effectiveness of the three sessions. The music should be selected on its ability to evoke physical energy and emotional elation in humans.

We note that the method is not limited to indoor instructional areas; the method may be practiced in other suitable areas.

### DETAILED DESCRIPTION OF THE INVENTION

Various aspects of the illustrative embodiments will be described using terms commonly employed by those skilled in the art to convey the substance of their work to others skilled in the art. However, it will be apparent to those skilled in the art that the present invention may be practiced with only some of the described aspects.

The phrase “one embodiment” is used repeatedly. The phrase generally does not refer to the same embodiment, however, it may. The terms “comprising”, “having” and “including” are synonymous, unless the context dictates otherwise.

The present invention is a detailed instructional method for mind, body, and spiritual integration, designed to promote and aid human wellness. In one embodiment, the present invention is based on a concerted series of sessions that combine the components of yogic practice, physical exercise, and inspirational music. The physical exercise component is obtained for example via indoor cycling using a stationary cycling machine. A supportive, spiritual philosophy for the method is also disclosed.

The spiritual philosophy behind the integrative method can be summarized in “5 Maxims”. These Maxims provide a mental framework for positively enhancing the method and should be actively considered during the instructional sessions.

1. “Be Love”. Be kind to your body and yourself. Accept yourself physical self without judging so that easier connection may be made with the mind and spirit. Gentle self love is personally enabling. One should attempt to be self-congruent with love, not existing separately from the feeling.

2. “Strive to a Higher Vibration”. There is an analogy between emotional level and “vibration” in the body, a psychological perception. Spiritually speaking, more pleasant feelings are associated with words such as “lighter, warmer, and fresher”. These terms and feelings are associated with happy or elated states and a feeling of well being and a subjective feeling of a “high vibration level”. Conversely, depressive or lethargic states are subjectively associated with a “low vibration level”. Such states indicate discomfort, and are characterized by the words “heavy, tired, weary, and slow. Thus this Maxim directs the participant to strive toward happier emotional states, which by analogy are sensed as higher vibrational levels.

3. “Peddle with the energy of the Higher Self”. With respect to the act of peddling the cycling machine, one should attempt to energize the motion of the physical body from a psychological center identified as “the Higher Self”, and permit enthusiasm to flow from this center. In contrast to the “Lower Self”, the perception of the Higher Self is that of happiness, love, kindness, and well being. The “Lower Self” is perceived as mischievous, greedy, angry, depressive, and selfish. By consciously observing Maxim 3, Maxim 2 is strengthened.

4. “Build from the Inside Out”. This Maxim directs the student to transform negative, “low vibration” emotional energy to positive emotional energy at the smallest level possible, imagining first even at the molecular scale of the body. The imagination then proceeds to larger structures, from tissues, to organs, and then to the whole body, first from the core, finally out to the limbs.

5. “Every Song is Important”. In each class music must have a central role to allow its immense importance to be realized. Musical songs should be chosen to have an energetic beat and rhythm to aid peddling, and also to assist in warming up and increasing positive emotional energy.

In one embodiment, the invention methodology comprises the following steps for one session, comprising three roughly timed segments. The pupils and instructor should select a comfortable area for stretching and listening and further choose and play inspirational music. Over about a 10 minute period, the student should gently relax and stretch according to yogic practice, thus energizing muscles and lubricating joint structures, while bringing body awareness to consciousness. The student should then move to the cycling machine and begin peddling for a period of about 40 minutes, while paying attention to breathing patterns and centers of energy in the body, and also visualizing positive images. The student should subsequently dismount the cycling machine, and gently refocus and calm the mind and body through yogic meditation practice over about a 10 minute period. The duration of the three timed segments may be different than those above, based upon the discretion of the instructor.

Other exercise machines may be substituted for the cycling machine. Non-limiting examples of many such machines are: treadmill, stair stepper, elliptical machine, and rowing machine.

Additionally, other forms of meditation may be used during the warm-up session and the cool-down session. Non-limiting examples of many such meditation practices are diaphragmatic breathing, concentration meditation, autogenic training, mindful walking, sitting mindfulness meditation, mindfulness exercises, holy moment meditation, centering prayer, loving kindness meditation, archangel healing meditation, qigong, and tai chi.

The method should be practiced on a regular basis until physical and mental wellness of the student improves, as determined by the student or instructor. For increased benefit, however, the method should be practiced continuously on a daily or weekly basis.

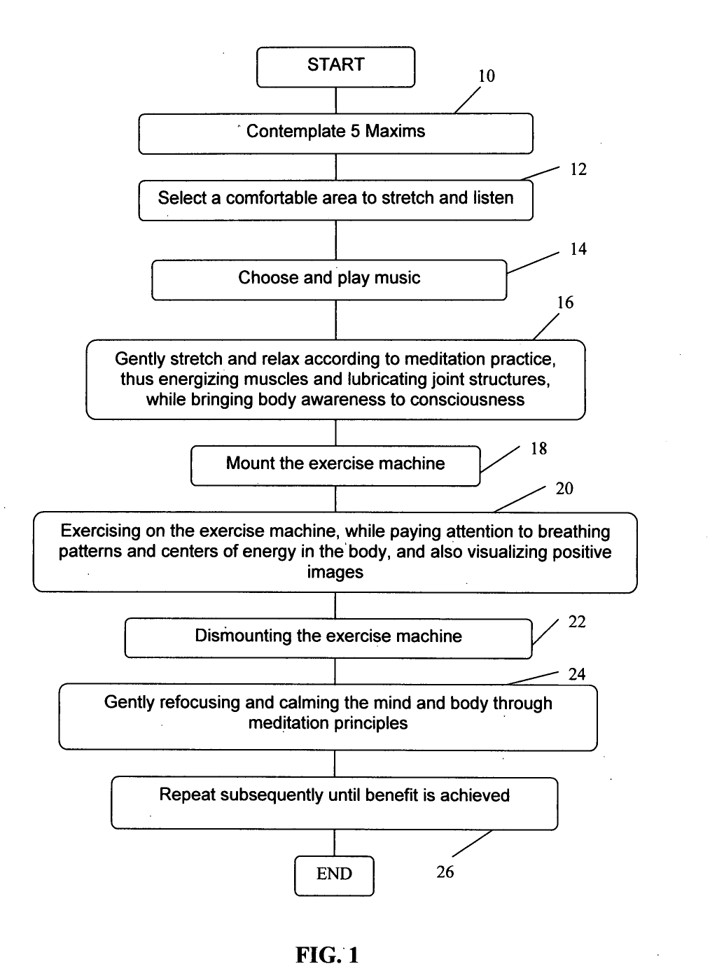

In FIG. 1 as in one embodiment shown is contemplate 5 Maxims 10 and select a comfortable area for stretching and listening 12. Also shown is choose and play music 14. Illustrated is gently stretching and relaxing according to meditation practice, thus energizing muscles and lubricating joint structures, while bringing body awareness to consciousness 16. Mount the exercise machine 18 and exercise on the exercise machine, while paying attention to breathing patterns and centers of energy in the body, and also visualizing positive images 20. Also shown is dismount the exercise machine 22 and gently refocus and calm the mind and body through meditation principles 24 repeating the session subsequently until benefit is achieved 26.

While the present invention has been related in terms of the foregoing examples, those skilled in the art will recognize that the invention is not limited to the examples depicted. The present invention can be practiced with modification and alteration within the spirit and scope of the appended claims. Thus, the description and examples are to be regarded as illustrative instead of restrictive on the present invention.

What is claimed is:

1. A method for aiding human wellness, performed with an instructor in an instructional area, further using an exercise machine, one session comprising:
contemplating 5 Maxims;
selecting a comfortable area for stretching and listening;
choosing and playing music;
gently stretching and relaxing according to meditation practice, thus energizing muscles and lubricating joint structures, while bringing body awareness to consciousness;
mounting the exercise machine;
exercising on the exercise machine, while paying attention to breathing patterns and centers of energy in the body, and also visualizing positive images;
dismounting the exercise machine;
gently refocusing and calming the mind and body through meditation principles; and,
repeating the session subsequently until benefit is achieved.

2. The method of claim 1 wherein the exercise machine is a stationary bicycle.

3. The method of claim 1 wherein the exercise machine is a treadmill.

4. The method of claim 1 wherein the exercise machine is a stair stepper.

5. The method of claim 1 wherein the exercise machine is an elliptical machine.

6. The method of claim 1 wherein the exercise machine is a rowing machine.

7. The method of claim 1 wherein the meditation practice is yoga.

8. The method of claim 1 wherein the meditation practice is diaphragmatic breathing.

9. The method of claim 1 wherein the meditation practice is concentration meditation.

10. The method of claim 1 wherein the meditation practice is autogenic training.

11. The method of claim 1 wherein the meditation practice is mindful walking.

12. The method of claim 1 wherein the meditation practice is sitting mindfulness meditation.

13. The method of claim 1 wherein the meditation practice is mindfulness exercise.

14. The method of claim 1 wherein the meditation practice is holy moment meditation.

15. The method of claim 1 wherein the meditation practice is centering prayer.

16. The method of claim 1 wherein the meditation practice is loving kindness meditation.

17. The method of claim 1 wherein the meditation practice is archangel healing meditation.

18. The method of claim 1 wherein the meditation practice is a selected one of qigong and tai chi.

19. The method of claim 1 wherein the instructional area is a selected one of an indoor instructional area and an outdoor instructional area.

20. A method for aiding human wellness, performed with an instructor in an indoor instructional area, further using a stationary bicycle, comprising the steps:
contemplating 5 Maxims;
selecting a comfortable area for stretching and listening;
choosing and playing music;
gently stretching and relaxing according to yogic practice for about 10 minutes, thus energizing muscles and lubricating joint structures, while bringing body awareness to consciousness;
mounting the stationary bicycle;
pedaling the stationary bicycle for about 40 minutes, while paying attention to breathing patterns and centers of energy in the body, and also visualizing positive images;
dismounting the stationary bicycle;
gently refocusing and calming the mind and body through yogic practice for about 10 minutes; and,
repeating the session subsequently until benefit is achieved.
